(19) United States
(12) Patent Application Publication
(10) Pub. No.: US 2016/0165942 A1
(43) Pub. Date: Jun. 16, 2016

(54) POULTRY SEASONING AND COOKING DEVICE

(71) Applicants: STEVEN J. ESPOSITO, SCOTTSDALE, AZ (US); CHERYL WILLIAMS, SCOTTSDALE, AZ (US)

(72) Inventors: STEVEN J. ESPOSITO, SCOTTSDALE, AZ (US); CHERYL WILLIAMS, SCOTTSDALE, AZ (US)

(21) Appl. No.: 14/799,278

(22) Filed: Jul. 14, 2015

Related U.S. Application Data
(60) Provisional application No. 62/036,752, filed on Aug. 13, 2014.

(51) Int. Cl. A23L 1/315; A23L 1/318

(52) U.S. Cl. CPC A23L 1/3155; A23L 1/3182; A23V 2002/00

(57) ABSTRACT

A cooking device configured to be placed in the cavity of poultry during cooking to season the poultry inside and out. The cooking device has an oblong shape that is commensurate with the oblong shape of the poultry cavity to maximize the seasoning of the poultry during cooking. The cooking device has a lid that is securable to a bottom member of the cooking device to prevent spillage of the seasoning during placement of the cooking device in the poultry cavity, and during the removal of the cooking device after cooking. The lid has downwardly extending flanges that secure within a rim of the bottom member to both lock and seal the lid in place. A handle allows safe placement and removal, of the cooking device, such as when the poultry is already in an oven, to prevent burns.

### CLAIM OF PRIORITY

This application claims priority under 35 U.S.C. Section 119(e) of U.S. Provisional Patent Application Ser. No. 62/036,752 entitled FOOD SEASONING DEVICE filed Aug. 13, 2014, the teachings of which are incorporated herein by reference in their entirety.

### FIELD OF THE DISCLOSURE

This disclosure is generally directed to cooking utensils and seasoning devices, and more particularly to cooking devices for poultry and other meats.

### BACKGROUND

Cooking devices are available for cooking poultry and meats, but which often are not conducive to cooking and seasoning poultry and other types of meats. Many existing cooking devices are not well suited to enable the full penetration of seasonings in poultry, may not be reusable, are messy, and which may not have ease of use to help prevent skin burns.

### SUMMARY

A cooking device configured to be placed in the cavity of poultry during cooking to season the poultry inside and out. The cooking device has an oblong shape that is commensurate with the oblong shape of the poultry cavity to maximize the seasoning of the poultry during cooking. The cooking device has a lid that is securable to a bottom member of the cooking device to prevent spillage of the seasoning during placement of the cooking device in the poultry cavity, and during the removal of the cooking device after cooking. The lid has downwardly extending flanges that secure within a rim of the bottom member to both lock and seal the lid in place. A handle allows safe placement and removal of the cooking device, such as when the poultry is already in an oven, to prevent burns.

### BRIEF DESCRIPTION OF THE FIGURES

FIG. 1 illustrates a perspective view of a cooking device configured to be placed in the cavity of poultry;

FIG. 2 illustrates a bottom view of the cooking device lower member with the lid removed;

FIG. 3 illustrates an end view of the cooking device from the end having the handle;

FIG. 4 illustrates an end view of the cooking device from the end opposite the handle;

FIG. 5 illustrates a top view of le cooking device including the lid;

FIG. 6 illustrates a side view of the cooking device showing the ear portions of the lid secured about a side rim portion of the bottom body portion;

FIG. 7 illustrates a sectional view of the cooking device taken along line 7-7 in FIG. 5; and

FIG. 8 illustrates a method according to this disclosure.

### DETAILED DESCRIPTION

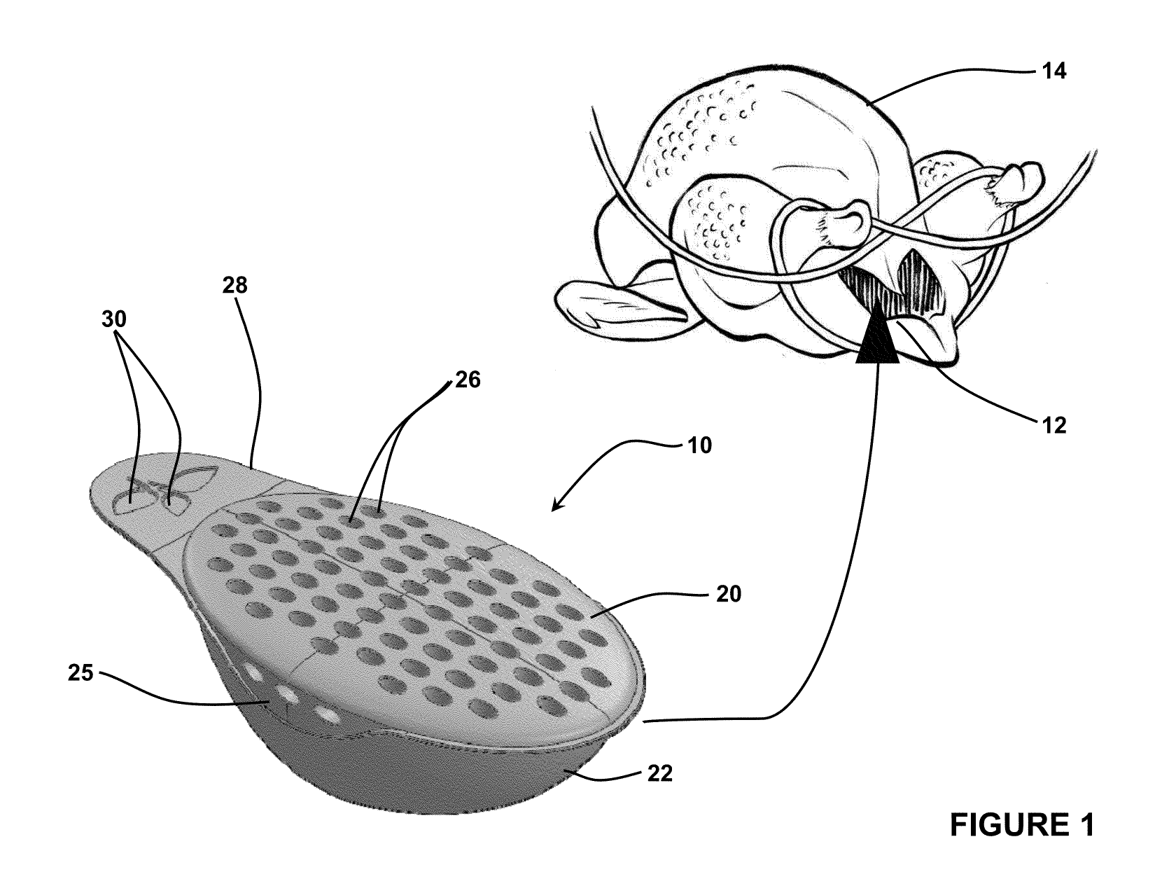

Referring to FIG. 1, there is shown a cooking device 10 having a curved oblong shape configured to be effectively placed in a cavity 12 of poultry 14 during cooking to season the poultry 14 both inside and out. The curved oblong shape of the cooking device 10 is commensurate with the shape of the curved oblong poultry cavity 12, allowing seasoning in the cooking device 10 to be uniformly and effectively released into the inside of the poultry 14. Examples of poultry include chicken, turkey, pheasant, grouse, duck just to name a few. Other meats may be seasoned with the cooking device 10 as desired.

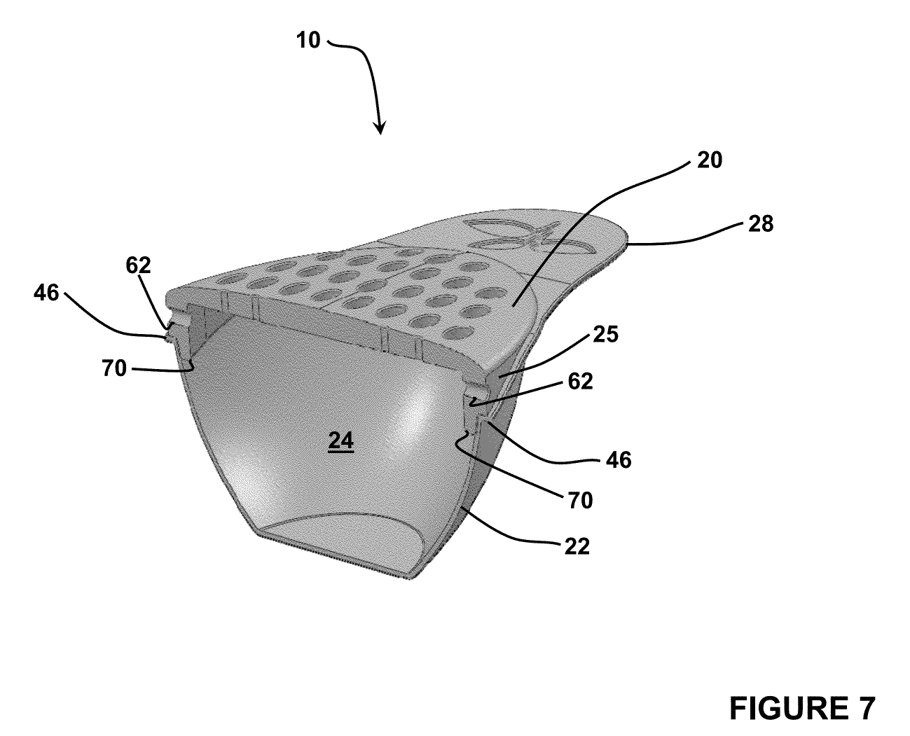

The cooking device 10 has a slightly bowed and generally planar upper member comprised of a removable lid 20, and a lower body member 22 configured to hold seasonings and spices in a device cavity 24 (FIG. 7) formed between the lower body member 22 and the lid 20. The device cavity 24 is completely surrounded and compassed by the lower body member 22 and the lid 20. The lid 20 has an inner flange and opposing ear portions 25 that are configured to be secured within an upper rim portion of the lower body member 22, and locked to the lower body member 22 to form a liquid seal. (FIG. 7) The lid 20 also has a plurality of openings 26 configured to allow the seasoning in the cooking device 10 to release into the poultry 14 and season the poultry 14 during cooking. The cooking device 10 has a side handle 28 extending in a generally common plane as the lid 20. The handle 28 has a textured recessed portion 30 and is configured to allow a user to safely place the cooking device 10 in the poultry cavity 12, and also remove the cooking device 10 from the poultry cavity 12, including once the poultry 14 is already placed in an oven. This helps prevent burns while allowing the cooking device 10 to be manipulated with the poultry 14.

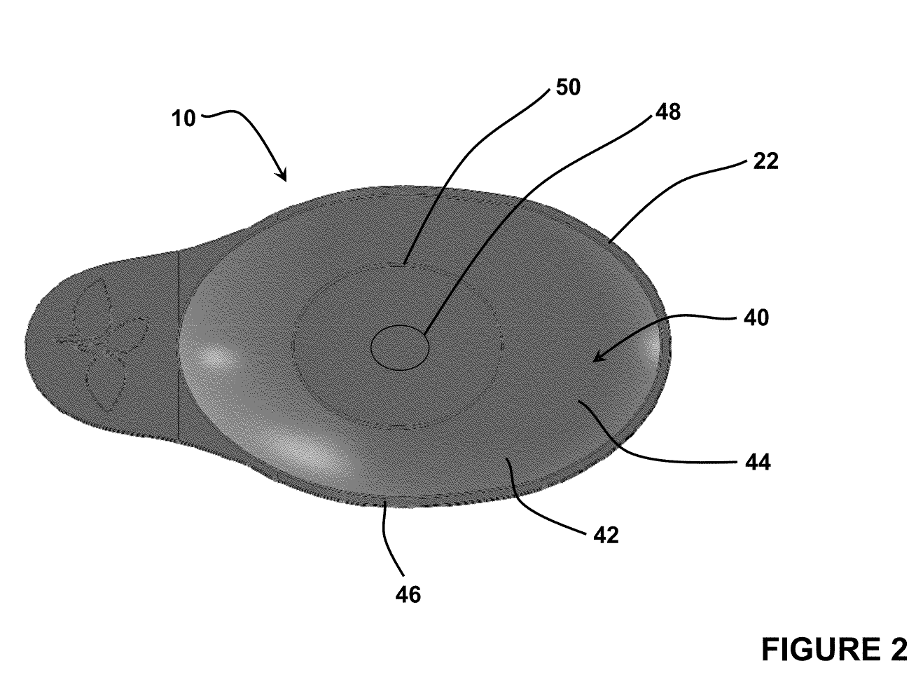

Referring to FIG. 2, the lower body member 22 has an elongated recess 40 and is generally boat-shaped. Boat-shaped is defined to be mean that the lower body member recess 40 is longer in length than it is wide, with generally vertical side walls 42 encompassing the recess 40, and an end sidewall portion 44 of the sidewalls 42 that is less inclined than the rest of the sidewalls. Although there is one continuous sidewall forming the recess 40, different portions of the sidewall are referred to separately to define the boat-shape of the lower body member 22. The sidewalls 42 form an upper rim 46 of lower body member 22 that is configured to lock to lid 20 to form a liquid seal, as will be discussed in more detail shortly. (FIG. 7) The lower body member 22 is seen to have the handle 28 laterally extend from the recess 40 on the side opposite the end sidewall portion 44. Seasoning 48, such as a capsule or packet of seasoning or spice(s), is disposed in the recess 40. Seasoning 48 can also be a powder, liquid, or other form of seasoning. The lower body member 22 has a flat bottom 50 configured such that the cooking device :10 can be seated horizontally in the poultry cavity 12 and prevent spilling of the seasoning 43. Both the lid 20 and the lower body member 22 are comprised of a food grade material, such as food grade silicone or stainless steel.

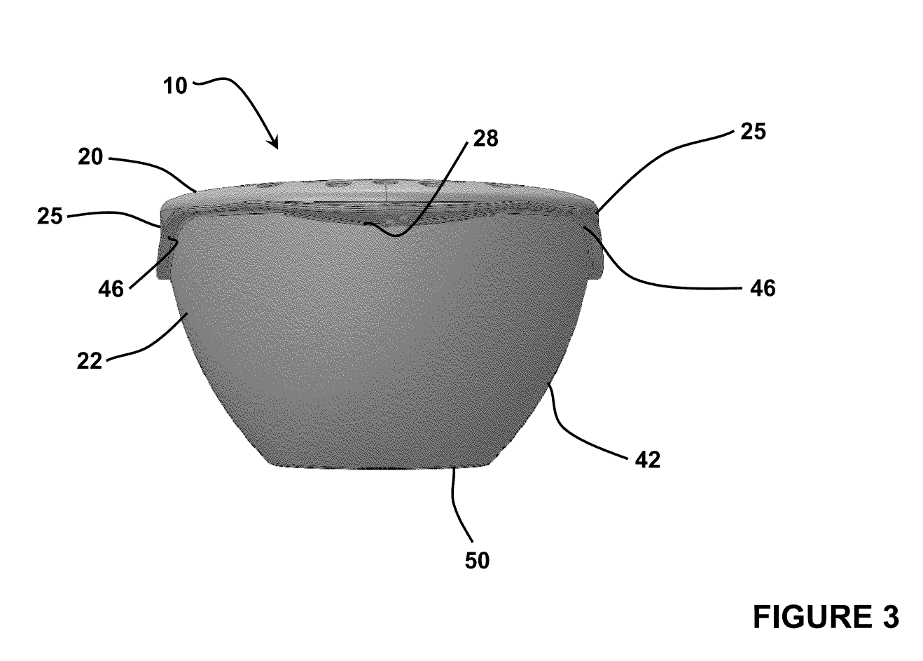

Referring to FIG. 3, there is shown an end view of the cooking device 10 at the end having handle 28. The lower body member 22 is seen to have curved sidewalls 42 bowing outwardly as they rise toward the rim 46, and narrowing toward the bottom SO, forming the boat-shaped lower body member 22. Also shown is the ear portions 25 which will be further described with reference to FIG. 7.

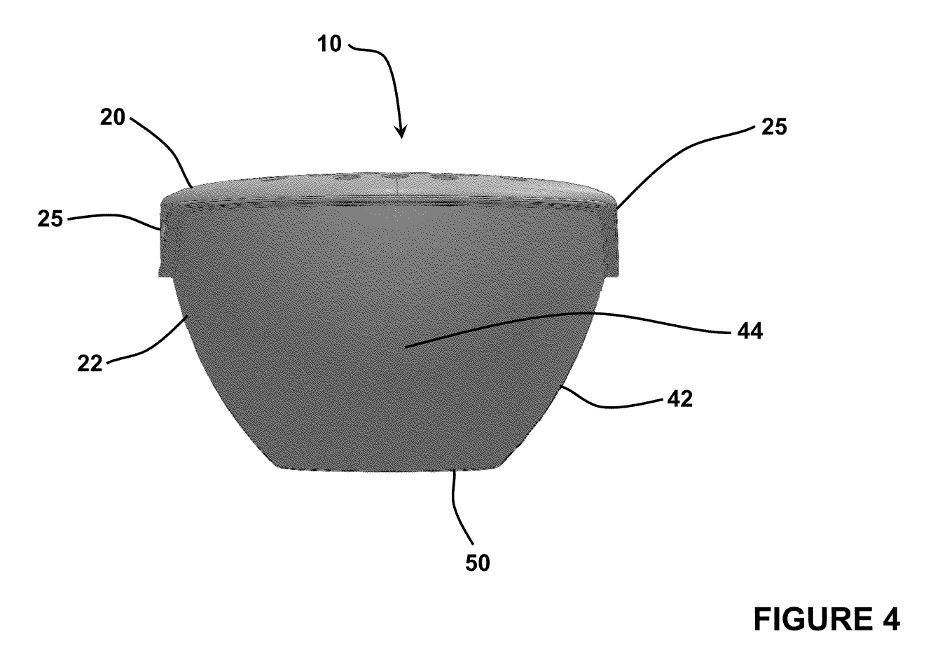

Referring to FIG. 4., there is shown an end view of the cooking device 10 at the end opposite the handle 28. This end of the cooking device 10 has sidewall portion 44 that is less inclined than the rest of the sidewalls 42 as previously discussed.

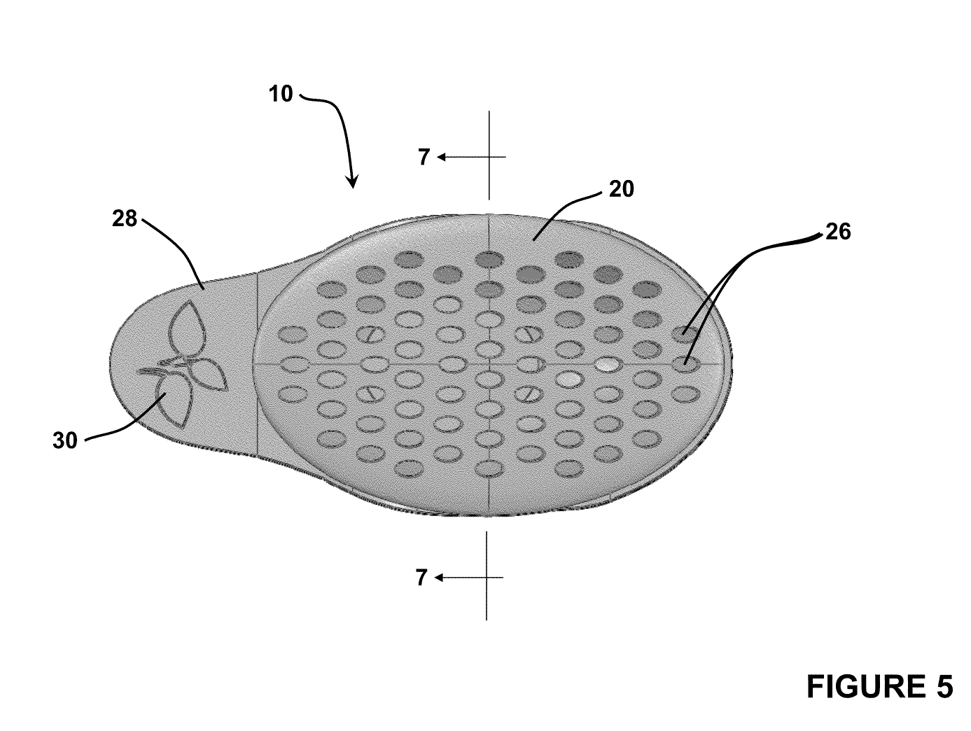

Referring to FIG. 5, there is shown a top view of the cooking device 10 illustrating the plurality of openings 26.

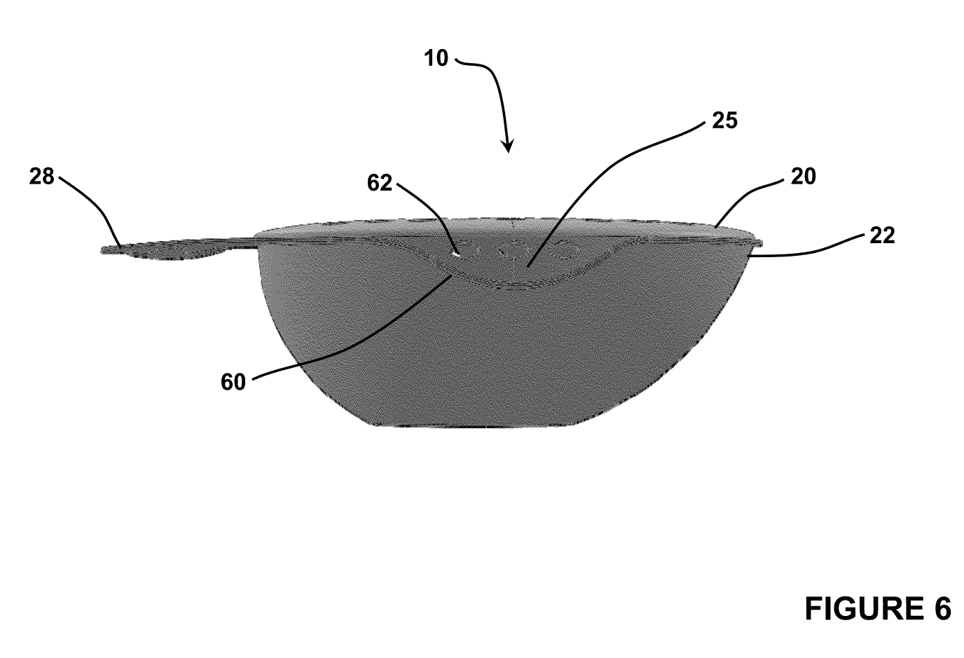

Referring to FIG. 6, there is shown a side view of the cooking device 10, wherein the handle 28 has a flange portion 60 tapering downwardly and extending each side of and secured to the lower body member 22. Flange portions 60 terminate below the respective ear portions 25 and provide structural rigidity when manipulating the cooking device 10. Also shown are openings 62 defined through the ear portions 25 and extending into the device cavity 24, configured to allow the seasoning 48 to release and vent to the sidewalls of the poultry cavity 12.

Referring to FIG. 7, there is shown a cross-sectional view of cooking device 10 taken along line 7-7 in FIG. 5. As shown, the lid 20 has a continuous inner flange 70 extending downwardly and inside the rim 46 of the lower body member 22. The flange 70 has a friction fit when inserted inside of the rim 46 to both lock the lid 20 to the lower body member 22, and provide a liquid seal to prevent leakage of the seasoning 48 from the body cavity 24. The outside diameter of the flange 70 is slightly greater than the inside diameter of the lower body member 22 to provide the friction fit.

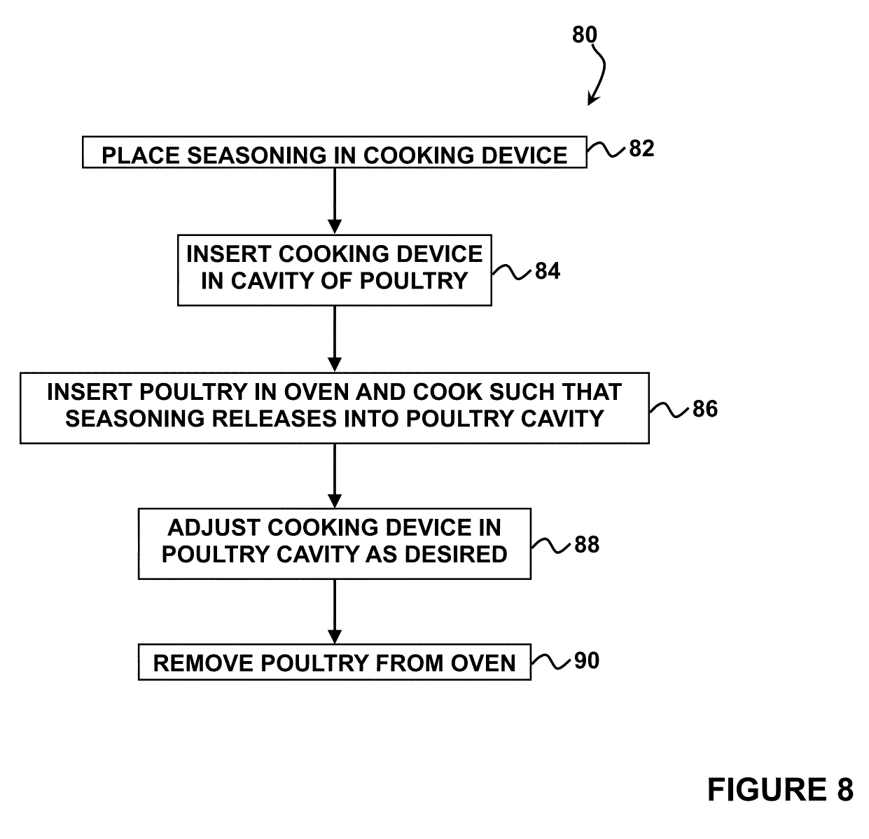

Referring now to FIG. 8, there is shown a method 80 of using the cooking device 10 to season poultry.

At step 82, seasoning 48 is placed in the cooking device by removing the lid 20 from the lower body member 22. The seasoning may in the form of a capsule, packet, power, liquid, or other form as desired. The lid 20 is then secured to the lower body member 22 to lock and form a liquid seal.

At step 84, the user places the oblong cooking device into the oblong shaped poultry cavity 12 of the poultry 14. The shape of the cooking device is commensurate with the shape of the poultry cavity such that seasoning can be uniformly and effectively released from the cooking device into the poultry.

At step 86, the user places the poultry 14 including the cooking device 10 into an oven such that the poultry 14 cooks and the seasoning 48 is uniformly released into the inside wall of the poultry cavity 12.

At step 88, the user may adjust the cooking device 10 in the poultry 14, This can include manipulating the cooking device 10 within the poultry cavity 12 such as to stir the seasoning 48. This could also include removing the cooking device 10 from the poultry 14 and checking on or replacing the seasoning 48 with additional or different seasoning, and then reinserting the cooking device 10 in the poultry 14 using handle 28 without removing the cooking device 10 from the oven.

At step 90, the user removes the seasoned poultry 14 from the oven, and removes the cooking device 10 from the poultry 14.

It will be obvious to those skilled in the art to make various changes, alterations and modifications. to the invention described herein. To the extent such changes, alterations and modifications do not depart from the spirit and scope of the appended claims, they are intended to be encompassed therein.

Those skilled in the art will realize that the process sequences described above may be equivalently performed in any order to achieve a desired result. Also, sub-processes may typically be omitted as desired without taking away from the overall functionality of the processes described above.

We claim:

1. A cooking device, comprising:
a body member configured to hold and diffuse a seasoning into poultry, the body member having an oblong shape and a device cavity therein, the body member comprising:
a bottom member having a sidewall and bottom rim forming an elongated boat-shaped receptacle, wherein the sidewall has an end portion tapering upwardly to the bottom rim and remaining portions of the sidewall are generally vertical, the bottom member having a handle opposite the end portion and configured to enable placing the cooking device into a cavity of poultry, and enable the removal of the cooking device from the poultry cavity, and
a removable top member having a top rim juxtaposed to the bottom rim and configured to form the device cavity when coupled to the bottom member, wherein the top member has at least one opening configured to allow release of seasoning in the device cavity into the poultry cavity.

2. cooking device as specified in claim 1, wherein the top member and the bottom member are configured to lock together.

3. The cooking device as specified in claim 2, wherein the top member and the bottom member for a liquid seal when locked together.

4. The cooking device as specified in claim 1, wherein the bottom member further includes a flat bottom configured to support the cooking device horizontally in the poultry cavity.

5. The cooking device as specified in claim 3 wherein the bottom member and the top member are comprised of food grade silicone or stainless steel.

6. The cooking device as specified in claim 5 wherein the handle has a textured surface configured to improve gripping by a user's hand.

7. The cooking device as specified in claim 3 wherein the cooking device has an outwardly curved and tubular cross section taken in a direction transverse to the tapered end portion.

8. A method of using a cooking device configured to hold and diffuse a seasoning into a poultry cavity, the cooking device having a body member having an oblong shape and a device cavity therein, the cooking device comprising:
a bottom member having a sidewall and bottom rim forming a boat-shaped receptacle, wherein the sidewall has an end portion tapering upwardly to the bottom rim and remaining portions of the sidewall are generally vertical, the bottom member having a handle opposite the end portion and configured to enable placing the cooking device into the poultry cavity, and enable the removal of the cooking device from the poultry cavity, and
a removable top member having a top rim juxtaposed to the bottom rim and configured to form the device cavity when coupled to the bottom member, wherein the top member has at least one opening configured to allow release of seasoning in the device cavity into the poultry cavity;
characterized in that the cooking device is used to both cook and season poultry by:
placing seasoning in the cooking device,
placing the cooking device into the poultry cavity, wherein the oblong shape of the cooking device is commensurate with an oblong shape of the poultry cavity, and
heating the poultry and the cooking device such that the seasoning releases into the poultry cavity.

9. The method as specified in claim 8, further comprising removing the cooking device from the poultry cavity while the poultry remains in an oven, and then reinserting the cooking device into the poultry cavity while the poultry is in the oven.

10. method as specified in claim 8, wherein the top member and the bottom member are configured to lock together.

11. The method as specified in claim 10, wherein the bottom member further includes a flat bottom configured to support the cooking device horizontally in the poultry cavity.

12. The method as specified in claim 10 wherein the bottom member and the top member are comprised of food grade silicone or stainless steel.

13. In combination:
poultry having a poultry cavity; and
a cooking device disposed in the poultry cavity, the cooking device comprising a body member having seasoning, the body member having an oblong shape and a device cavity therein, the body member comprising:
a bottom member having a sidewall and bottom rim forming an elongated boat-shaped receptacle, wherein the sidewall has an end portion tapering upwardly to the bottom rim and remaining portions of the sidewall are generally vertical, the bottom member having a handle opposite the end portion and configured to enable placing the cooking device into a cavity of poultry, and enable the removal of the cooking device from the poultry cavity, and
a removable top member having a top rim juxtaposed to the bottom rim and configured to form the device cavity when coupled to the bottom member, wherein the top member has at least one opening configured to allow release of seasoning in the device cavity into the poultry cavity.

14. The combination as specified in claim 13, wherein the body member shape conforms to a shape of the poultry cavity.

15. The combination as specified in claim 13, wherein the top member and the bottom member are configured to lock together and form a liquid seal.

16. The combination as specified in claim 15, wherein the bottom member has a flat bottom configured to support the cooking device horizontally in the poultry cavity.

17. The combination as specified in claim 16 further comprising a plurality of openings in the top member.

18. The combination as specified in claim 13 wherein the bottom member and the top member are comprised of food grade silicone or stainless steel.

19. The combination as specified in claim 13 wherein the handle has a textured surface configured to improve gripping by a user's hand.

20. The combination as specified in claim 13 wherein the cooking device has an outwardly curved and tubular cross section taken in a direction transverse to the tapered end portion.
